(19) United States
(12) Patent Application Publication
(10) Pub. No.: US 2010/0165385 A1
(43) Pub. Date: Jul. 1, 2010

(54) IMAGE PROCESSING APPARATUS AND CONTROL METHOD THEREFOR

(75) Inventor: Shuya Saeki, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/631,553

(22) Filed: Dec. 4, 2009

(30) Foreign Application Priority Data
Dec. 8, 2008 (JP) 2008-312376

(51) Int. Cl. G06F 3/12

(52) U.S. Cl. 358/1.15

(57) ABSTRACT

An apparatus includes an image processing unit changeable in circuit configuration, and control such that the image processing unit performs processing of a plurality of partial images to be processed by using a first circuit configuration of the image processing unit out of a plurality of partial images being input by using the first circuit configuration of the image processing unit, and makes control such that the image processing unit performs processing of a plurality of partial images to be processed by using a second circuit configuration of the image processing unit out of a plurality of partial images being input by using the second circuit configuration of the image processing unit.

### BACKGROUND OF THE INVENTION

1. Field of the Invention

The present invention relates to an image processing apparatus, a program, and a control method of the image processing apparatus.

2. Description of the Related Art

Conventionally, high image quality printing is performed for image processing apparatuses, which acquire image data that is scanned by a scanner or sent from a host computer, and perform various types of image processing on the acquired data to rasterize the image data as print data.

In order to perform the high image quality printing, the data is to be process by the image processing apparatuses using dedicated image processing according to an attribute such as a pixel attribute or a surface attribute of each page. The pixel attribute indicates whether the data of an image is based on a character or a photograph. The surface attribute indicates whether the image of the data is sent from, for example, a scanner, or a host computer.

Japanese Patent Application Laid-Open No. 2007-081795 discusses a method by which load of a plurality types of image processing performed by an image processing apparatus is optimized by appropriately using the attributes. If the image processing apparatus is equipped with the dedicated hardware for each image processing, however, the circuit size and cost will be increased. Thus, Japanese Patent Application Laid-Open No. 2006-285792 discusses an image forming apparatus including a processing unit capable of executing each of the plurality types of image processing and a control unit for controlling the processing unit.

However, according to the above-described conventional image processing apparatus, when image data having various attributes is sequentially input to the apparatus, the time for changing the processing unit will increase, and as a result, the total processing time will increase.

### SUMMARY OF THE INVENTION

According to an aspect of the present invention, an apparatus includes an image processing unit changeable in circuit configuration, an input unit configured to input an image including a plurality of first partial images to be processed by using a first circuit configuration and a plurality of second partial images to be processed by using a second circuit configuration, and a control unit configured to control such that the image processing unit performs processing of the plurality of first partial images by using the first circuit configuration without changing the circuit configuration, and processing of the plurality of second partial images by using the second circuit configuration without changing the circuit configuration.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a system including an image processing apparatus according to an exemplary embodiment of the present invention.

FIG. 2 is a flowchart illustrating processing performed by a control unit when image data is sent to the control unit from a scanner.

FIG. 3 is a flowchart illustrating processing performed by the control unit when PDL data is sent to the control unit from a host computer.

FIG. 4 is a flowchart illustrating processing of intermediate data performed by a scheduler by reading out the intermediate data stored in a storage device and instructing the image processing unit to process the intermediate data.

FIG. 5 is a flowchart illustrating processing performed by a control unit by reading out the intermediate data stored in a storage device and sending the data to a print engine unit so that printing according to the intermediate data can be performed by the print engine unit.

FIG. 6 is a configuration (format) example of the intermediate data.

FIG. 7 is a configuration (format) example of attribute information.

FIG. 8 is a block diagram illustrating a basic configuration of the image processing unit.

FIG. 9 is an example of 2-in-1 (2-up) page layout.

FIG. 10 is a flowchart of scheduling processing performed by the scheduler.

FIG. 11 illustrates an example of scheduling.

FIG. 12 illustrates a configuration of a scheduling signal processing circuit, which is changed when the scheduling is performed.

### DESCRIPTION OF THE EMBODIMENTS

Various exemplary embodiments, features, and aspects of the invention will be described in detail below with reference to the drawings.

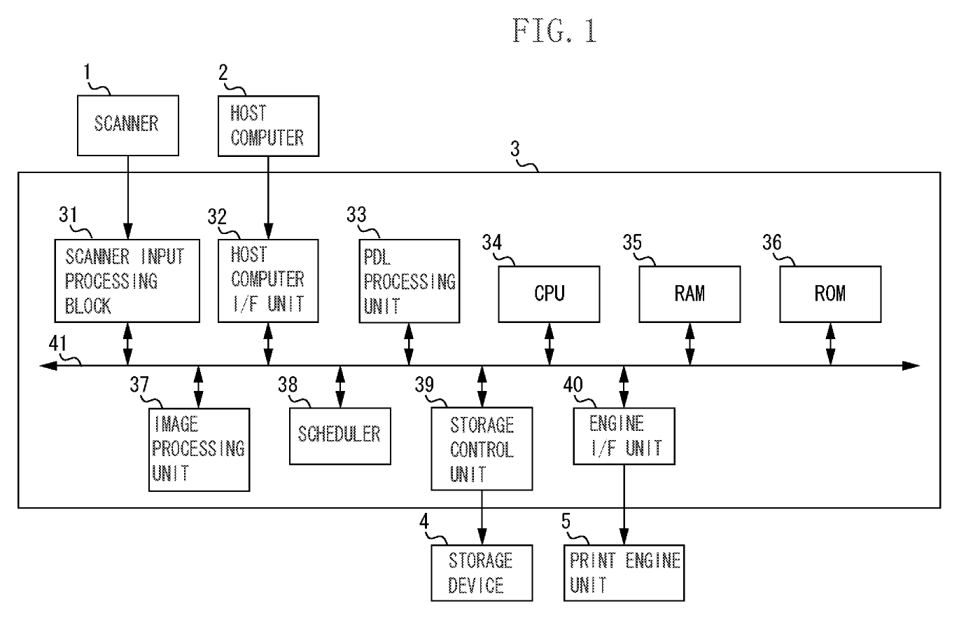

FIG. 1 is a block diagram illustrating a configuration of a system including an image processing apparatus according to an exemplary embodiment of the present invention. The system illustrated in FIG. 1 includes a scanner 1, a host computer 2, a control unit 3, a storage device 4, and a print engine unit 5.

The scanner 1 scans information (e.g., image, character) recorded on a recording medium such as paper, and outputs the information as image data. The output image data is input to the control unit 3.

The host computer 2 may be a computer such as a general personal computer (PC) or a workstation (WS). Images and documents generated by the host computer 2 are input to the control unit 3 as PDL data.

Since the control unit 3 is capable of receiving data output from the scanner and the host computer 2, the control unit 3 and the scanner 1, and further, the control unit 3 and the host computer 2 are connected via a network so that data communication is possible. The configuration of the network, however, is not limited to a specific configuration.

The control unit 3 performs various types of image processing based on the data sent from the scanner 1 or the host computer 2, and outputs the processed image data. Details of the control unit 3 and the processing performed by the control unit 3 will be described in detail below.

The storage device 4 records and stores the image data output from the control unit 3. The print engine unit 5 prints the image data, which is output from the control unit 3, on a storage medium such as paper. Although the apparatuses that supply data to the control unit 3 are the scanner 1 and the host computer 2 according to the present embodiment, a different type of apparatus such as a multifunction peripheral or a facsimile machine can also supply the data to the control unit 3.

Next, the configuration of the control unit 3 will be described. The control unit 3 includes a scanner input color processing block 31, a host computer I/F unit 32, a PDL processing unit 33, a central processing unit (CPU) 34, a random access memory (RAM) 35, a read-only memory (ROM) 36, an image processing unit 37, a scheduler 38, a storage controller unit 39, and an engine I/F unit 40.

The scanner input color processing block 31 performs color processing. In other words, the scanner input color processing block 31 receives the image data that is sent from the scanner 1 in R/G/B format and converts the received data into Y/M/C/K format by color processing. In addition to the color conversion processing, the scanner input color processing block 31 determines whether the attribute of the input image data specifies a character image or specifies a photographic image. A known determination method can be used as a method for determining the attribute on a pixel-by pixel basis.

The host computer I/F unit 32 functions as an interface unit that receives the PDL data sent from the host computer 2. The type of the host computer I/F unit 32 is compatible with the network that connects the control unit 3 and the host computer 2. For example, an Ethernet (registered trademark) interface, a serial interface, or a parallel interface can be used as the host computer I/F unit 32.

The PDL processing unit 33 performs rasterizing processing on the PDL data received via the host computer I/F unit 32. In addition to the processing of the PDL data, the PDL processing unit 33 determines whether the attribute of the input image data specifies a character image or specifies a photographic image on a pixel-by-pixel basis. The attribute can be determined by a known determination method.

The CPU 34 performs control of the entire control unit 3 using a computer-readable control program or data, which is stored in the RAM 35 or the ROM 36. Further the CPU 34 executes the processing performed by the control unit 3. The processing is described below.

The RAM 35 includes an area used for temporarily storing the data sent from the scanner 1 via the scanner input color processing block 31 or the data sent from the host computer 2 via the host computer I/F unit 32. Additionally, the RAM 35 includes a work area to be used by the CPU 34 when the CPU 34 executes the various types of processing.

The ROM 36 stores programs and data. Such programs and data are used by the CPU 34 when it controls the entire control unit 3 or when it instructs the control unit 3 to perform the various types of processing described below. Further, setting data of the control unit 3 is also stored in the ROM 36.

The image processing unit 37 performs image processing of the image based on the data that is sent from the scanner 1 or the host computer 2. Details of the processing performed by the image processing unit 37 will be described below. The scheduler 38 determines the order of the intermediate data to be transferred to the image processing unit 37. Details of the processing performed by the scheduler 38 will be described below.

The storage controller unit 39 controls the recording processing of the image data processed by the control unit 3 to store the image data in the storage device 4. The engine I/F unit 40 performs a series of processing for sending the image data, which is image-processed by the control unit 3, to the print engine unit 5. A bus 41 connects each of the above-described units.

Next, processing to be performed by the control unit 3 when the data is sent from the scanner 1 or the host computer 2 to the control unit 3 will be described.

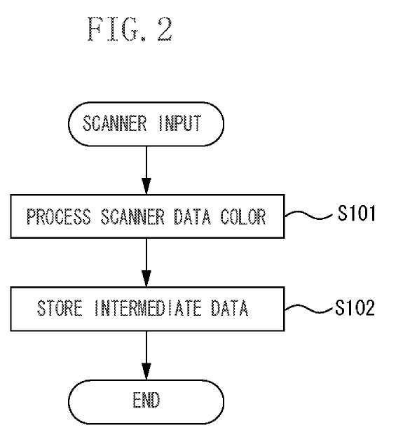

FIG. 2 is a flowchart illustrating processing to be performed by the control unit 3 when image data is sent from the scanner 1 to the control unit 3. Here, an example of a case where the CPU 34 controls the processing by a program stored in the ROM 36 and according to the flowchart will be described so as to simplify the description. However, a CPU or a program is not always in the processing and a dedicated hardware that executes the processing described below may also be used.

If the CPU 34 detects that the image data sent from the scanner 1 is received via the scanner input color processing block 31, the processing according to the flowchart in FIG. 2 is started.

In step S101, the CPU 34 instructs the scanner input color processing block 31 to execute various types of color processing on the image data. The CPU 34 temporarily stores the image data, which has undergone the color processing and the attribute determination processing, in the RAM 35.

In step S102, the CPU 34 generates the attribute information for each pixel that is included in the image data after the image data has gone through the color processing, and generates intermediate data. The intermediate data includes the generated attribute information and the image data, which has undergone the color processing, as a set. Then, the intermediate data is sent to the storage device 4 via the storage controller unit 39. Thus, the intermediate data is stored in the storage device 4.

If the attribute assigned to each pixel is unchanged for all the pixels in 1 page, then the attribute is determined to be the surface attribute. If both a photographic image and a character image are included in a page, a surface attribute, which indicates that the page includes both types of images, is assigned. Further, an input source (in this case, the scanner) of the image data can be identified according to the surface attribute.

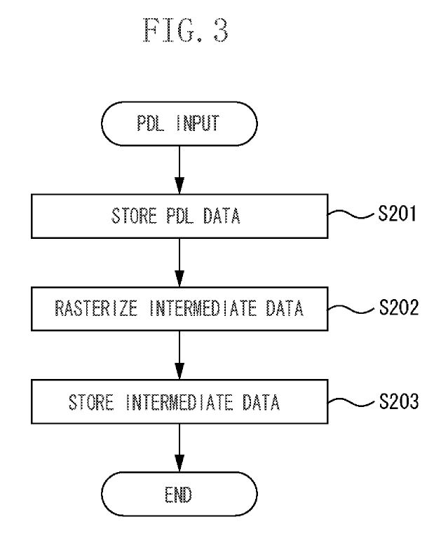

FIG. 3 is a flowchart illustrating processing to be performed by the control unit 3 when PDL data is sent from the host computer 2 to the control unit 3. Here, an example of a case where the CPU 34 controls the processing by a program stored in the ROM 36 and according to the flowchart will be described so as to simplify the description. However, a CPU or a program is not always in the processing and a dedicated hardware that executes the processing described below may also be used.

If the CPU 34 detects that the PDL data sent from the host computer 2 is received via the host computer I/F unit 32, the processing according to the flowchart in FIG. 3 is started.

In step S201, the CPU 34 temporarily stores the received PDL data in the RAM 35. In step S202, the CPU 34 instructs the PDL processing unit 33 to generate the above-described intermediate data using the PDL data. In other words, the PDL processing unit 33 generates a set of information including data for each pixel included in the image expressed by the PDL data, which is sent from the host computer 2, and the attribute information of each pixel.

If the attribute assigned to each pixel is unchanged for all the pixels in 1 page, then the attribute is determined to be the surface attribute. If both a photographic image and a character image are included in a page, a surface attribute, which indicates that the page includes both types of images, is assigned. Further, an input source (in this case, the host computer) of the image data can be identified according to the surface attribute.

In step S203, the CPU 34 sends the generated intermediate data to the storage device 4 via the storage controller unit 39. Accordingly, the intermediate data is stored in the storage device 4.

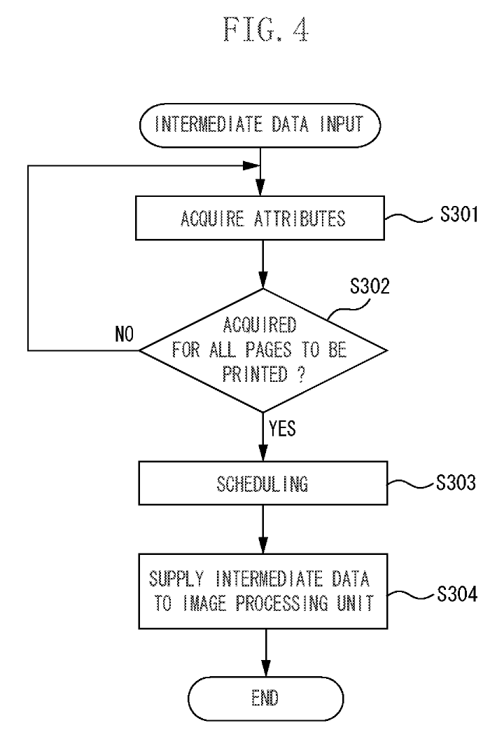

FIG. 4 is a flowchart illustrating processing to be performed by the control unit 3 after the intermediate data is stored in the storage device 4. Here, an example of a case where the CPU 34 controls the processing by a program stored in the ROM 36 and according to the flowchart will be described so as to simplify the description. However, a CPU or a program is not always in the processing and a dedicated hardware for executing the processing described below may also be used.

In step S301, the CPU 34 instructs the image processing unit 37 so that the intermediate data stored in the storage device 4 is loaded to the RAM 35. The CPU 34 causes the image processing unit 37 to acquire the surface attribute that is assigned to each page and the pixel attribute that is assigned to each pixel with respect to the loaded intermediate data.

In step S302, the acquisition process is repeated a number of times equal to the number of pages to be printed. Thus, in the case of N-up printing, attributes for N pages are acquired. In step S303, the CPU 34 instructs the scheduler 38 to perform scheduling based on the acquired attributes. The image data for each pixel is processed by an image processing circuit having a different circuit configuration depending on whether the attribute is of a photographic image or a character image.

Thus, in order to make the change of the circuit configuration less frequently, the image data having the same attribute type is scheduled to be processed together. Accordingly, the order of the image data to be transferred to the image processing unit is determined.

Details of the scheduling processing performed in step S303 will be described below. In step S304, the CPU 34 transfers the intermediate data from the RAM 35 to the image processing unit 37 according to the scheduling.

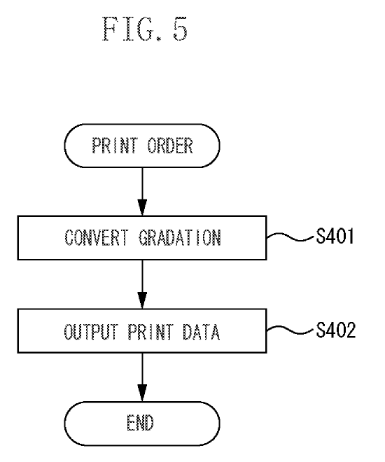

FIG. 5 is a flowchart illustrating processing performed by the control unit 3 when the intermediate data stored in the storage device 4 is read out and sent to the print engine unit 5. Here, an example of a case where the CPU 34 controls the processing according to a program stored in the ROM 36 and according to the flowchart will be described so as to simplify the description. However, a CPU or a program is not always for the processing and a dedicated hardware that executes the processing described below can also be used.

In step S401, the CPU 34 reads out the intermediate data stored in the storage device 4 according to the instruction given by the scheduler 38 and loads the intermediate data to the RAM 35. Then, the CPU 34 instructs the image processing unit 37 to execute gradation conversion of the loaded intermediate data. Details of the processing in step S401 will be described below.

In step S402, since the intermediate data is converted into print data according to the above-described processing, the print data is output to the print engine unit 5.

According to the above-described processing, data sent from either the scanner 1 or the host computer 2 can be converted into intermediate data to be stored. Further, in printing the data, image processing such as gradation conversion is applied to the intermediate data, and then the obtained result can be sent to the print engine unit 5.

Although the intermediate data is temporarily stored in the storage device 4 in the above description, image processing such as gradation conversion can be directly performed on the intermediate data. Then, the obtained result may be sent to the print engine unit 5. This eliminates the process of storing the generated intermediate data in the storage device 4.

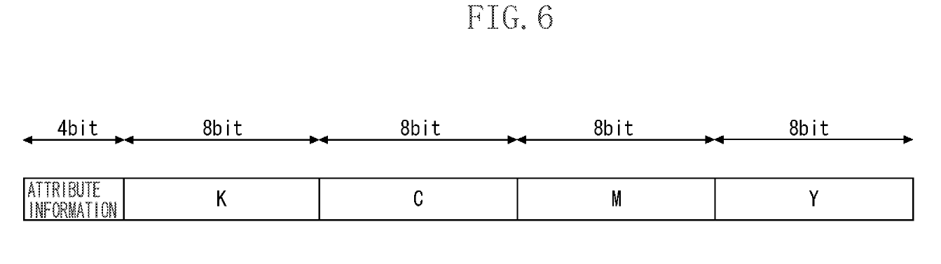

FIG. 6 illustrates an example of a configuration (format) of the intermediate data. As described above, the intermediate data includes data of each pixel included in the image and attribute information of each pixel. More particularly, as illustrated in FIG. 6, the intermediate data includes YMCK data of a pixel, and attribute information of the pixel. Although the attribute information in FIG. 6 is expressed in 4 bit data and Y, M, C, and K data of each piece is expressed in 8 bit data, data in different bit values can also be used. Further, color data of a color space other than the YMCK color space can also be used.

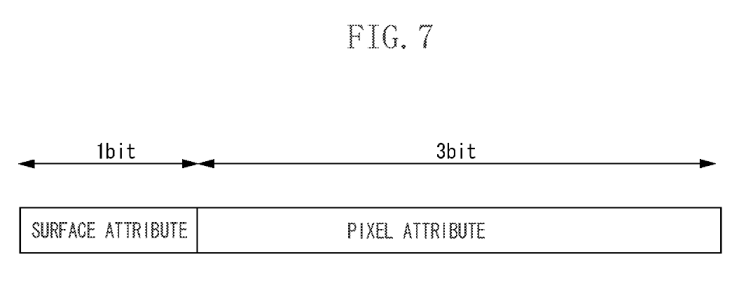

FIG. 7 illustrates an example of a configuration (format) of the attribute information illustrated in FIG. 6. As illustrated in FIG. 7, the attribute information includes a surface attribute and a pixel attribute. The surface attribute indicates whether the pixel data (RGB data according to the present exemplary embodiment) is sent from the scanner 1 or from the host computer 2.

For example, if the surface attribute “1” is defined to indicate that the source of the data is the scanner 1, and further, if the surface attribute “0” is defined to indicate that the source of the data is the host computer 2, then the source of the intermediate data can be determined by referring to the surface attribute.

According to the present exemplary embodiment, the intermediate data is based on the data that is obtained from either the scanner 1 or the host computer 2. Thus, the surface attribute of either “1” or “0” will be used. Accordingly, the input mode can be expressed in 1 bit. However, if the control unit 3 is capable of receiving data from more apparatuses, the bit value used is to be increased in expressing the surface attribute according to the number of the apparatuses.

The pixel attribute is information that specifies the area of the image from which the pixel data (YMCK data according to the present embodiment) included in the intermediate data is taken. The area is, for example, a photograph area or a character area. Although the area information is expressed in 3 bits, the bit value is not limited to this.

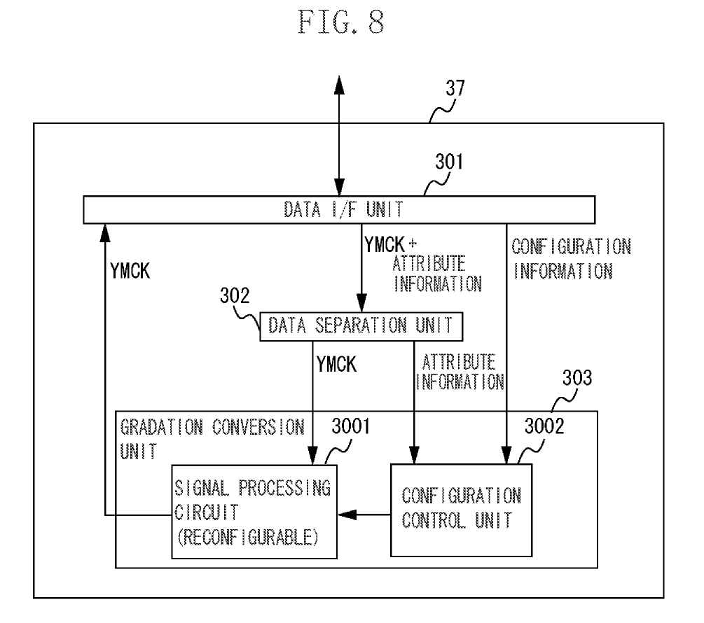

FIG. 8 is a block diagram illustrating a basic configuration of the above-described image processing unit 37. As illustrated in FIG. 8, the image processing unit 37 includes a data I/F unit 301, a data separation unit 302, and a gradation conversion unit 303.

A signal processing circuit (reconfigurable) 3001 is configured such that it can change its circuit configuration to execute various gradation data conversion processing. The configuration can be changed in relatively short time.

The pixel data sent from the data separation unit 302 is processed by the signal processing circuit 3001. The configuration control unit 3002 determines the configuration of the signal processing circuit 3001 according to the attribute information that the configuration control unit 3002 receives from the data separation unit 302. Further, depending on the attribute information, the configuration control unit 3002 determines the configuration of the signal processing circuit 3001 after the configuration control unit 3002 receives the configuration information from the data I/F unit 301. The circuit configuration change processing of the signal processing circuit 3001 that is changed according to the attribute information is described below.

Next, operation of the gradation conversion unit 303 will be described. The configuration control unit 3002 is included in the gradation conversion unit 303. The configuration control unit 3002 instructs the signal processing circuit 3001 to change its circuit configuration depending on the image area information included in the attribute information sent from the data separation unit 302.

In other words, if the surface attribute is “0” and the pixel attribute is “101”, the configuration control unit 3002 instructs the signal processing circuit 3001 to change its circuit configuration so that gradation data conversion processing for characters can be performed by using pulse-surface-area modulation.

Further, if the surface attribute of the next pixel is unchanged but the pixel attribute is changed to “011”, the configuration control unit 3002 temporarily stops the image processing and instructs the signal processing circuit 3001 to change its circuit configuration so that gradation data conversion processing for characters can be performed by using pulse-surface-area modulation. If the surface attribute does not change as described above, the configuration control unit 3002 itself gives instruction to the signal processing circuit 3001.

Next, a case where the surface attribute of the next pixel is changed from “0” to “1” and the pixel attribute is “101” will be described. In this case, the configuration control unit 3002 temporarily stops the image processing and receives the configuration information from outside of the image processing unit via the data I/F unit 301 so that the circuit configuration of the signal processing circuit 3001 is changed and the gradation data conversion processing for characters can be performed by using error diffusion method.

Then, the configuration control unit 3002 changes the circuit configuration according to the configuration information. Further, if the surface attribute of the next pixel is unchanged but the pixel attribute is changed to “011”, the configuration control unit 3002 temporarily stops the image processing and instructs the signal processing circuit 3001 to change its circuit configuration so that gradation data conversion processing for characters can be performed by using the error diffusion method.

As described above, when an attribute changes, the image processing unit 37 temporarily stops the image processing and changes the circuit configuration according to the new attribute. Further, if the time for changing the circuit configuration when the pixel attribute is changed and the time for changing the circuit configuration when the surface attribute is changed are compared, the latter will take a longer time by the time in receiving the configuration information. If the circuit configuration change time when the pixel attribute is changed is T1 and the circuit configuration change time when the surface attribute is changed is T2, then T1 will be smaller than T2.

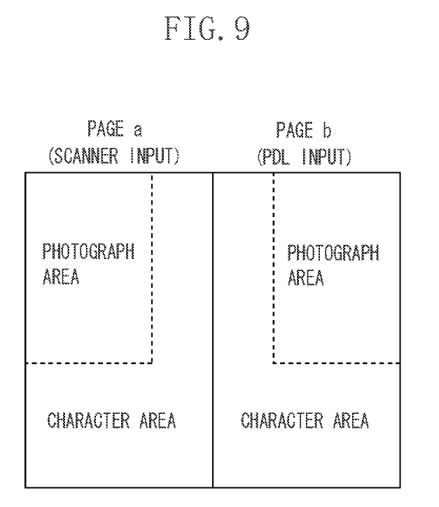

Next, details of the scheduling that is performed in step S303 of FIG. 4 will be described referring to FIGS. 9, 10, and 11.

FIG. 9 is an example of a 2-in-1 (2-up) page layout. According to the processes executed in the flowcharts in FIGS. 2 and 3, the distribution of the image data is determined as illustrated in FIG. 9. Page “a” includes image data that is sent from the scanner 1. Page “b” includes image data that is sent from the host computer 2. The image data in page “b” is in PDL format. Each of pages “a” and “b” includes a character area and a photograph area.

A surface attribute and a pixel attribute are assigned to each pixel. According to the present exemplary embodiment, a surface attribute “1” and a pixel attribute “011” are assigned to each of the pixels in the photograph area in page “a”, and a surface attribute “1” and a pixel attribute “101” are assigned to each of the pixels in the character area in page “a”. Further, a surface attribute “0” and a pixel attribute “011” are assigned to each of the pixels in the photograph area in page “b”, and a surface attribute “0” and a pixel attribute “101” are assigned to each of the pixel in the character area in page “b”.

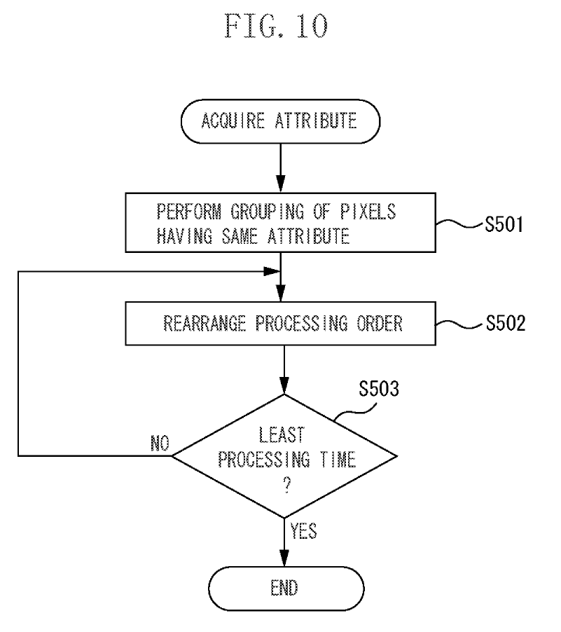

FIG. 10 is a flowchart illustrating the scheduling processing performed by the scheduler 38. Here, an example of a case where the scheduler 38 controls the processing according to a program stored in a ROM (not illustrated) and according to the flowchart will be described so as to simplify the description.

However, a CPU or a program is not always in the processing and a dedicated hardware that executes the processing described below can also be used. Further, the CPU 34 can control the processing according to a program stored in the ROM 36.

In step S501, after acquiring the attributes of the number of pages to be printed, the scheduler 38 classifies the pixels in the scanner character area and in the PDL photograph area according to the attribute type and performs grouping of the pixels.

In step S502, the order of the pixel groups to be transferred to the image processing unit 37 is rearranged. The different groups have different attributes from each other. Thus, the circuit configuration is to be changed by the image processing unit 37. Accordingly, the image processing is stopped for a while, and the circuit configuration change time T1 or T2 occurs in the processing.

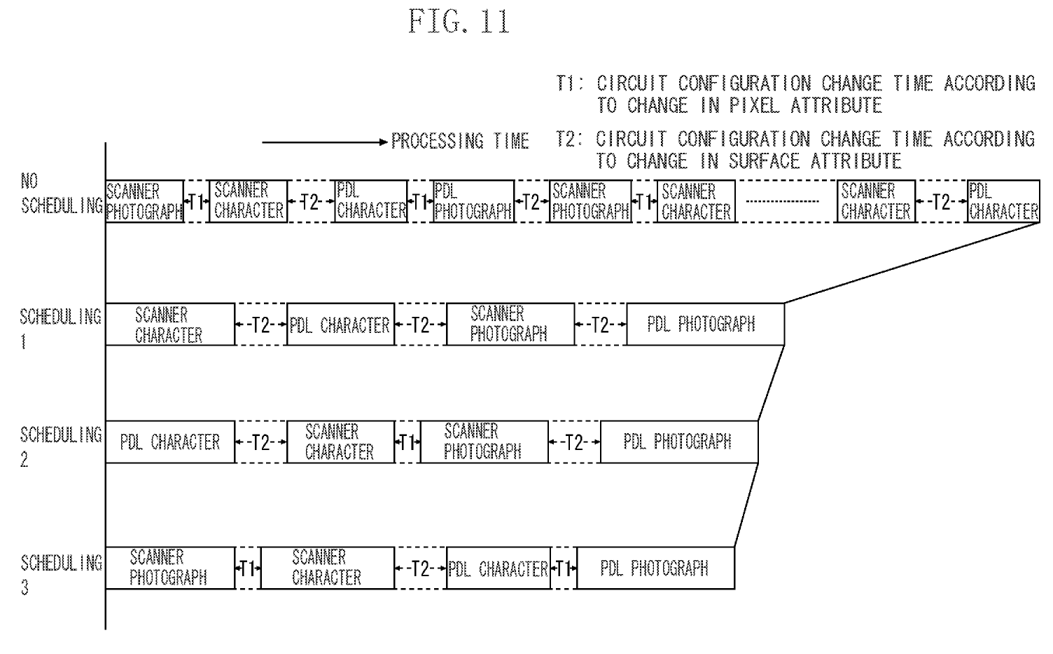

If a plurality of pixel groups exist, a combination of T1 or T2 occurs according to the pages to be printed. In order to reduce the processing time, the processing time is to be determined so that the combination time of T1 and T2 is minimum. In step S503, the scheduler 38 rearranges the combination of T1 and T2 until the minimum time is obtained. Details of the rearrangement will be described below referring to FIG. 11.

FIG. 11 illustrates the scheduling processing performed by the scheduler 38. If the page illustrated in FIG. 9 is sequentially scanned from the upper left corner to the lower right corner, and the obtained result is input to the image processing unit, the processing time will be what is described as “no scheduling” in FIG. 11. Since the circuit configuration change occurs each time the area or the page is changed, printing will take an extremely long time.

As described above referring to FIG. 10, the scheduler 38 performs grouping of the pixels having the same attribute in a page, and determines scheduling of the image data to be transferred to the image processing unit. Examples of the scheduling are given as “scheduling 1”, “scheduling 2”, and “scheduling 3” in FIG. 11.

Where the combination time of T1 or T2 is T, the number of times T1 occurs is M, and the number of times T2 occurs is N, T can be obtained from the formula (1) below.

T=T1×M+T2×N (1)

The scheduling is performed so that T is the smallest.

When the grouping of the pixels having the same attribute is completed, the number of the generated groups will equal to the number of attributes of the page. In other words, “M+N” will be fixed after the grouping. Thus, if T1 is smaller than T2, a smallest T can be obtained by scheduling so that N is minimized.

In the case of “scheduling 1”, pixels are grouped according to whether the pixel attribute is character or photograph. Although the processing time of “scheduling 1” is shorter than that of “no scheduling”, since N=3, T2 occurs rather frequently.

In the case of “scheduling 2”, pixels are grouped according to whether the pixel attribute is character or photograph, and further, according to the surface attribute of scanner. If “scheduling 2” is compared with “scheduling 1”, since N=2, the number of times of T2 is reduced.

In the case of “scheduling 3”, pixels are grouped according to whether the pixel attribute is character or photograph, and further, according to whether the surface attribute is scanner or PDL. If “scheduling 3” is compared with “scheduling 2”, since N=1, the number of times of T2 is reduced.

According to the example of 2-in-1 printing described above, there are two types surface attributes (i.e., scanner and PDL), however it is impossible to achieve N=0. Thus, the “scheduling 3” produces the least processing time, and the image data is transferred to the image processing unit 37 according to the “scheduling 3”.

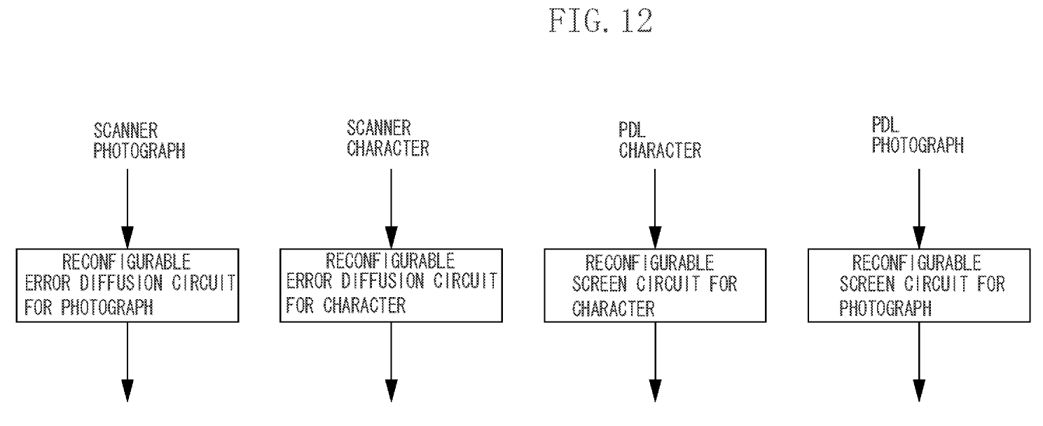

FIG. 12 illustrates the change in the configuration of the signal processing circuit 3001 when the scheduling is performed.

As can be seen from FIG. 12, the configuration of the circuit that performs the image processing changes according to the source of the input image and the attribute of the image. Thus, by collectively processing the image data that can be processed by a certain circuit configuration as much as possible, the number of times the configuration of the circuit is changed so that different image processing is performed can be significantly reduced compared to when the processing is performed according to the order of input. Thus, according to the present exemplary embodiment, various types of image processing can be performed while reducing the processing time.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

A function of the above-described exemplary embodiments is realized not only when the computer executes the program code. For example, an operating system (OS) or the like which runs on a computer can execute a part or whole of the actual processing based on an instruction of the program code so that the function of the above-described exemplary embodiments can be achieved.

Further, the program code read out from the recording medium is written in a memory in a function expanding board inserted in a computer or a function expanding unit connected to the computer and a CPU provided in the function expanding board or the function expanding unit performs the whole or a part of the actual processing based on an instruction from the program to realize the functions of the above-described exemplary embodiments.

If the present invention is applied to the above-described recording medium, a program code corresponding to the flowchart described above will be stored in the recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-312376 filed Dec. 8, 2008, which is hereby incorporated by reference herein in its entirety.

What is claimed is:

1. An apparatus comprising:
an image processing unit changeable in circuit configuration;
an input unit configured to input an image including a plurality of first partial images to be processed by using a first circuit configuration and a plurality of second partial images to be processed by using a second circuit configuration; and
a control unit configured to control such that the image processing unit performs processing of the plurality of first partial images by using the first circuit configuration without changing the circuit configuration, and processing of the plurality of second partial images by using the second circuit configuration without changing the circuit configuration.

2. The apparatus according to claim 1, further comprising:
a determination unit configured to determine an order of processing to be performed by using the first circuit configuration and the second circuit configuration,
wherein the control unit controls such that the processing to be performed by using the first circuit configuration and the processing to be performed by using the second circuit configuration are performed in the order determined by the determination unit.

3. The apparatus according to claim 2, wherein the determination unit determines the order such that a time the control unit takes for changing the circuit configuration of the image processing unit becomes minimum.

4. The apparatus according to claim 1, wherein a partial image of one of the first and second partial images is formed in a pixel.

5. The apparatus according to claim 1, wherein the first partial image has a first attribute, and the second partial image has a second attribute, and
wherein the control unit controls such that the image processing unit performs processing of the plurality of first partial images having the first attribute by using the first circuit configuration without changing the circuit configuration, and the image processing unit performs processing of the plurality of second partial images having the second attribute by using the second circuit configuration without changing the circuit configuration.

6. The apparatus according to claim 1, further comprising:
an execution unit configured to execute grouping the plurality of first partial images into a first group, and execute grouping the plurality of second partial images into a second group,
wherein the control unit controls such that the plurality of first partial images in the first group are processed by the image processing unit by using the first circuit configuration without changing the circuit configuration, and the plurality of second partial images in the second group are processed by the image processing unit by using the second circuit configuration without changing the circuit configuration.

7. A method for controlling an apparatus including an image processing unit changeable in circuit configuration, the method comprising:
inputting an image including a plurality of first partial images to be processed by a first circuit configuration and a plurality of second partial images to be processed by a second circuit configuration; and
controlling such that processing of the plurality of first partial images is performed by using the first circuit configuration without changing the circuit configuration, and controlling such that processing of the plurality of second partial images is performed by using the second circuit configuration without changing the circuit configuration.

8. The method according to claim 7, further comprising:
determining an order of processing to be performed by using the first circuit configuration and the second circuit configuration,
wherein the controlling controls such that the processing to be performed by using the first circuit configuration and the processing to be performed by using the second circuit configuration are performed in the order determined by the determining.

9. The method according to claim 8, wherein the determining determines the order such that a time the controlling takes for changing the circuit configuration of the image processing unit becomes minimum.

10. The method according to claim 7, wherein a partial image of one of the first and second partial images is formed in a pixel.

11. The method according to claim 7, wherein the first partial image has a first attribute, and the second partial image has a second attribute, and
wherein the controlling controls such that the image processing unit performs processing of the plurality of first partial images having the first attribute by using the first circuit configuration without changing the circuit configuration, and the image processing unit performs processing of the plurality of second partial images having the second attribute by using the second circuit configuration without changing the circuit configuration.

12. The method according to claim 7, further comprising:
executing grouping the plurality of first partial images into a first group, and execute grouping the plurality of second partial images into a second group,
wherein the controlling controls such that the plurality of first partial images in the first group are processed by the image processing unit by using the first circuit configuration without changing the circuit configuration, and the plurality of second partial images in the second group are processed by the image processing unit by using the second circuit configuration without changing the circuit configuration.
